(19) United States
(12) Patent Application Publication
(10) Pub. No.: US 2002/0021262 A1
(43) Pub. Date: Feb. 21, 2002

(54) DISPLAY DEVICE WITH SEVERAL LIGHT SOURCES AND ARRANGEMENT OF DISPLAY DEVICES

(76) Inventor: HANS-JORG REMITZ, RITTERHUDE (DE)

Correspondence Address: STEINGBERG & WHITT, 1215 TOTTENHAM COURT, RESTON, VA, 20194

(21) Appl. No.: 09/230,246

(22) PCT Filed: Jul. 24, 1997
(86) PCT No.: PCT/EP97/04003

(30) Foreign Application Priority Data
Jul. 25, 1996 (DE) 196 30 011.8

(51) Int. Cl. G09G 3/04

(52) U.S. Cl. 345/33

(57) ABSTRACT

A process is disclosed for generating a display by using individually controllable light sources, as well as a display device with several light sources. A process for generating a display uses multiple individually controllable light sources which can be excited to light up by a control unit. This type of display was generally used until now for publicity purposes or in apparatuses. The light sources form a chain of light sources or several light sources are arranged in a matrix. Information is displayed in that all light sources are excited to light up, in the case of a chain of light sources, or in that part of the light sources is excited to light up, in the case of a matrix of light sources. The object of the invention is to provide a display with as few as possible light sources, while avoiding the above-mentioned problems, and which allows the representation of all alphanumeric signs, as well as other types of signs. This problem is solved by a process for generating a display which uses multiple individually controllable light sources which can be excited to light up by a control unit. The light sources are moved back and forth several times per unit of time over a surface and during that time individual or several light sources are excited to light up when they pass by a determined point. The surface covered by the light sources forms part of or the entire display surface. Advantageous developments of the process are described in dependent claims 2 and 3.

The invention concerns a display device for generating a display using a light source array with individually actuable light sources which can be excited to light up by a control unit. Hitherto displays of this type were generally used in advertising or also in apparatuses, in which case the light sources are arranged in the form of a light source chain or a plurality of light sources are arranged in a matrix and information is displayed by either all light sources in the light source chain or a part in the case of a light source matrix being excited to light up.

If the light sources are for example arranged in such a way that a plurality of light sources embody for example an alphanumeric character, then such an arrangement only allows the display of the respectively desired alphanumeric character, while a matrix arrangement of a plurality of light sources means that various alphanumeric characters can be generated. In the case of a matrix arrangement however a very large number of light sources is required in order to represent the multiplicity of alphanumeric characters. With a 10×20 matrix for example 200 light sources are already required, in which respect light emitting diodes, incandescent lamps or LCD-elements are usually employed as the light sources. It is precisely when involving a matrix comprising many light sources that the expenditure in terms of hardware is very high and the probability of failure of an individual light source is considerably higher than when few light sources are involved.

EP-0 359 218-A discloses a display instrument in which lighting elements which are oriented linearly on a pointer are moved transversely to the direction of movement of the pointer and a control circuit switches the lighting elements on and off in dependence on the instantaneous position of the pointer to form display symbols during the pointer movement. In that arrangement the pointer can be moved to and fro like a pendulum or it can rotate continuously.

In addition, Patent Abstracts of Japan, No 59-195 181 (application No 50-70553) to the applicants Seikoushiya K.K. discloses a similar display device to that known from EP-0 359 218-A, in which lighting elements arranged on a pendulum arm are moved to and fro transversely to their linear orientation within a predetermined unit of time, so that the display of a desired item of information is generated, using the so-called afterimage phenomenon.

The display principle which is known from the above-described publications is distinguished in that only very few light sources are required, and that it is possible to generate a display for which the viewer cannot discern any display carrier such as for example a picture tube as in the case of television, but the viewer sees the display as virtually floating freely in space in front of the background.

The object of the invention is to design a display on the basis of the after-image phenomenon in a simple and inexpensive manner and to allow a high degree of display variability. The invention further seeks to provide a practically noise-less display device.

In accordance with the invention, that object is attained by a display device having a plurality of light sources arranged on a carrier, a control device for actuation of an individual light source and/or a subgroup of light sources,

with a drive which is coupled to the carrier and which is controlled by the control device and which so moves the carrier that the light sources pass repetitively a plurality of times over a surface region within a given unit of time,

a storage means connected to the control means for the storage of an item of display information, and

a device for the detection of position and/or motion information of the carrier, wherein the position and/or motion information can be transmitted to the control device and a light source is controllable by the is control device in dependence on the position and/or motion information of the display information.

Advantageous developments are described in the appendant claims as well as an arrangement comprising a plurality of display devices.

It has been found that, when the carrier is driven in a contact-less mode, it is possible to construct an in particular noise-less display device. Such a contact-less drive for the carrier can be afforded by an electromagnetic unit or solenoid which cyclically exposes a pendulum arm in the form of the carrier to an attraction and/or repulsion force.

In addition, a contact-less drive as well as the contact-less detection of the information in respect of position and/or motion of the carrier has the advantage that the amount of wear of the display device according to the invention is limited to a minimum. Furthermore, contactless data transmission from the fixed part of the display device to the moving part of the display device is also advantageous, and this can be ensured for example by contact-less coupling of the control device with respect to the carrier and the light sources disposed thereon.

If nonetheless the movement of the carrier, either in the case of the pendulum movement or in the case of a rotational movement on a cylindrical path, should give rise to acoustic noises, noise generation of that kind can be counteracted by virtue of the carrier being of an aerodynamically favourable configuration. When the carrier is of such an aerodynamic configuration, the man skilled in the art, with the assistance of knowledge of the aerodynamic shaping of for example aircraft wings, will avoid the carrier externally having corners or other discontinuous contours at which acoustic disturbance noises can be generated due to the flow of air there.

It has also proven to be highly desirable that, to detect information in respect of position and/or motion of the carrier, a detector, preferably a light barrier arrangement or a proximity switch, is used, so that a position and/or motion information signal is generated in dependence on the position of the carrier, the control device using that information signal as a reference signal for light source control purposes and for drive control purposes. The production of acoustic noises is also prevented by contact-less detection of the information in respect of position and/or motion of the carrier, as described hereinbefore.

By virtue of the reference signal, the control device can exactly implement the actuation of an individual light source and at the same time can also control the drive in such a way that the carrier is repeatedly moved over the display surface sufficiently frequently and at exact time intervals. It is also desirable if, when a pendulum-like reciprocating motion is involved, the representation generated is produced in each phase of the motion, that is to say in the forward movement and in the return movement of the carrier. In that way, on the one hand the level of sharpness of the display is enhanced and at the same time the carrier does not have to be moved over the display surface so frequently.

In addition, the control signal can switch each individual light source on and off, in dependence on the reference signal and in dependence on the items of information to be displayed, in such a way that each individual light source lights up only at a given location on the display surface. Moreover, in the case of a forward movement and a return movement of a pendulum-like display, the display is synchronised in such a way that the display in the forward movement optically overlaps with the display in the return movement.

It is also advantageous if the display device is provided with means for ascertaining the level of ambient brightness so that the lighting strength or power of the light sources can be adjusted in dependence on ambient brightness.

It has also proven to be highly desirable if, for individual information display, an individual one of the above-mentioned display devices or a plurality thereof is connected to an information input/processing device, wherein the information input/processing device is preferably a personal computer at which, by utilisation and by implementation of an editing program provided for display control purposes, the user is capable of inputting the content of the information to be displayed. For that purpose, the content to be displayed is firstly once put into intermediate storage in a memory in the computer and transferred with a suitable command on the part of the user to the selected display unit where the display information is stored in the storage means there.

It is moreover advantageous if, in the case of an arrangement comprising a plurality of display devices, each individual display device has an individual address which allows the user to be displayed the item of information to be displayed, on the display unit that he wants.

The display principle of the above-described display device is based on the fact that, when a plurality of light sources are repetitively moved in the same manner over a given surface, it is possible to generate a display which is built up in line form, as an individual given light source repeatedly passes over the same surface of a given surface region. If an individual light source is switched on or off during the motion, a given optical lighting effect can be produced for the viewer in the respective display line. If the light sources move a plurality of times per second over a given region, then a still image can be produced for the viewer by the co-operation of excited light sources, without the viewer even seeing the carrier of the light sources in the display surface. That therefore generates an image which, from the light sources which are switched on and off, generates a displayed image for which the viewer cannot give an image carrier if the motion of the carrier of the light sources is just so fast that the carrier itself can no longer be identified. In this respect the invention makes use of a psycho-optical persistence effect which always -occurs in the event of rapid movements of light spots and which is known for example from the film and television industry, where ultimately movements are produced by for example more than 25 still images per second being produced on the television picture screen or on the movie screen. The succession of closely consecutive different static events like successive still images which differ in given points produces on the part of the viewer the impression of a movement.

Due to the movement of the individual light sources over the surface region, an imaginary matrix is produced, in which the ratio of the number of light sources and the matrix points or dots is very small. For example it is possible without difficulty to create an imaginary matrix of about 8×(50 to 200) picture elements with only 8 light sources which are disposed linearly on a straight line and which are rapidly reciprocated transversely to their orientation, without the quality of the image produced becoming inadequate. The cost for generating the display in regard to the light sources themselves is therefore drastically reduced in comparison with a known matrix arrangement. On the other hand, the movement of the light sources is very easily possible, insofar as for example the carrier of the light sources is cyclically reciprocated or rotates about a point.

An astonishing optical effect can be achieved with the display device according to the invention. The viewer sees an information display without discerning the actual carrier of the information display such as for example a picture screen or a representational matrix. Therefore, where the light sources do not light up, the viewer can discern the background behind the display.

The display device according to the invention can be of a particularly advantageous configuration if the drive moves the carrier of the light sources to and fro like a pendulum or rotates it about a point of rotation. In that case, the light sources are moved for example more than 20× per second over the same surface within a given unit of time.

A particularly advantageous embodiment is one in which the light sources are arranged one behind the other on a straight line on the free end of a pendulum arm. It is then easily possible to produce a display surface of more than 10 cm in width, each individual light source forming a line of the display.

For information display, the display device has a storage means which transfers the items of information to be displayed to the control device, either in the form of whole items of information or in the form of individual information in point form. If the display device serves as a clock, the display device includes a timer which transmits items of time information corresponding to the dependency of a time signal to the control device which in turn, by way of the light sources, displays the time information in digital and/or analog form as the clock time.

Therefore, the control device converts a signal for an item of information to be displayed, for example a number, into actuation signals for each individual light source so that the light sources are excited to light up at a given moment in time and at a given position.

It will be appreciated that it is also possible for items of information to be displayed not just statically but also as moving writing or lettering on the display device. For that purpose, the position at which a light emitting diode lights up is only displaced towards one side of the display surface, between successive passes.

The invention is described in greater detail hereinafter by means of an embodiment illustrated in the drawings in which:

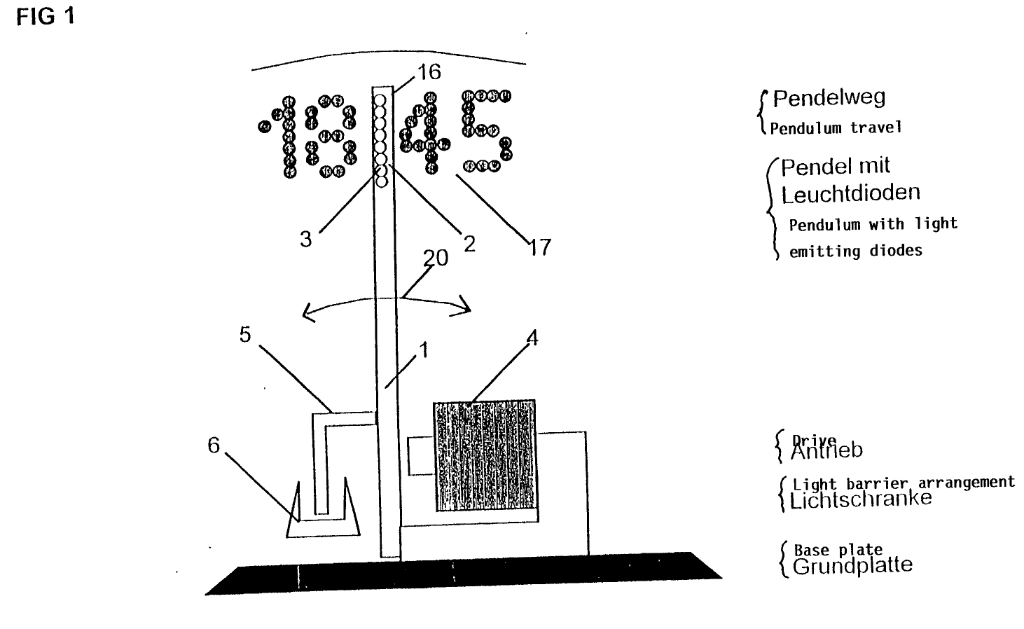

FIG. 1 is a plan view showing the principle of the display according to the invention,

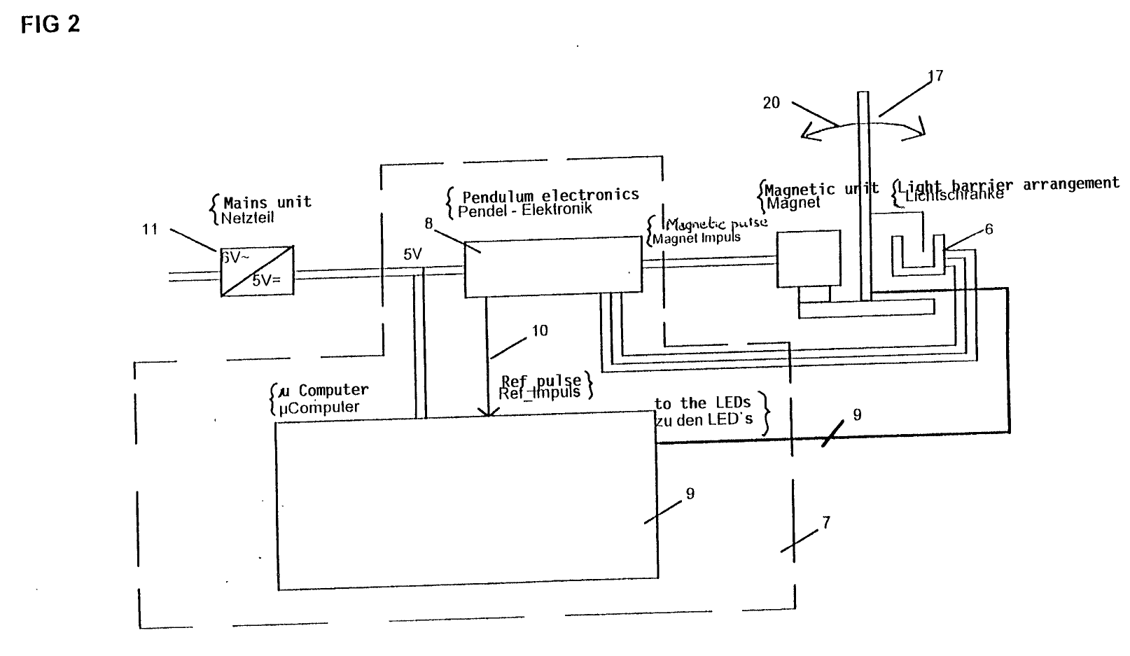

FIG. 2 is a schematic block circuit diagram of the display according to the invention,

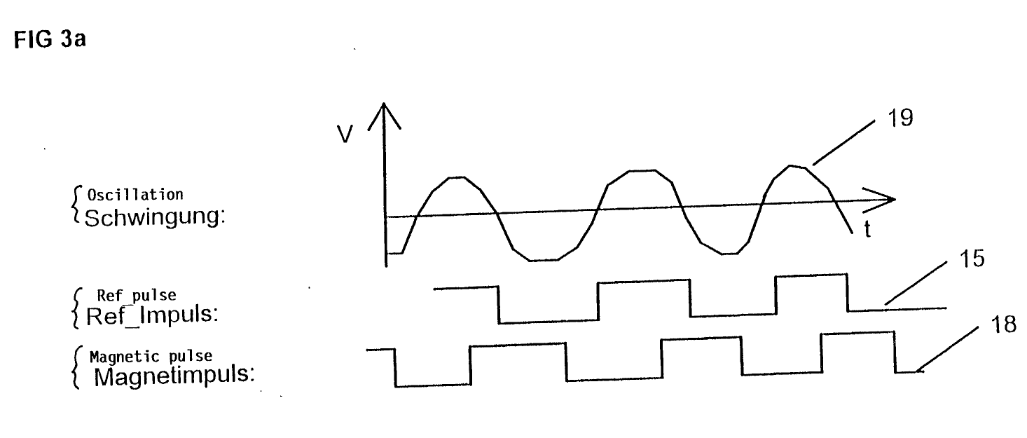

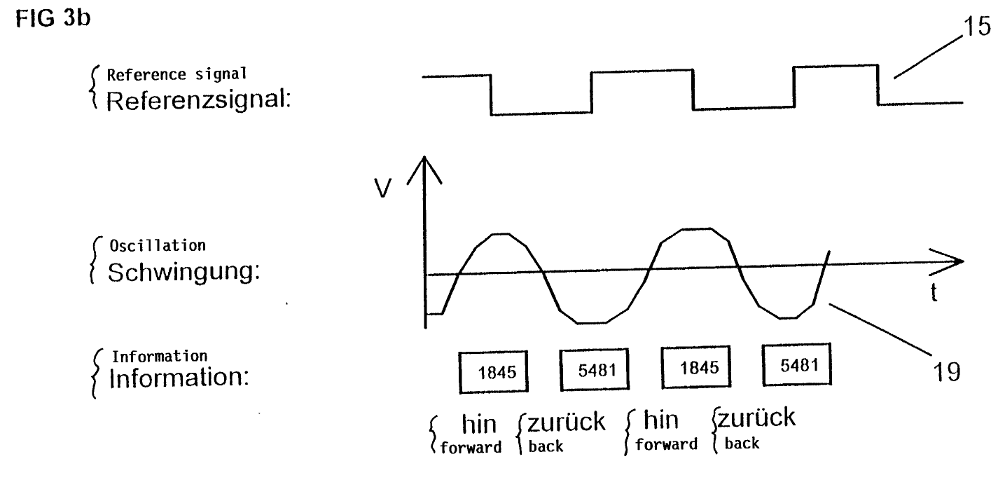

FIG. 3 shows timing diagrams of the device according to the invention,

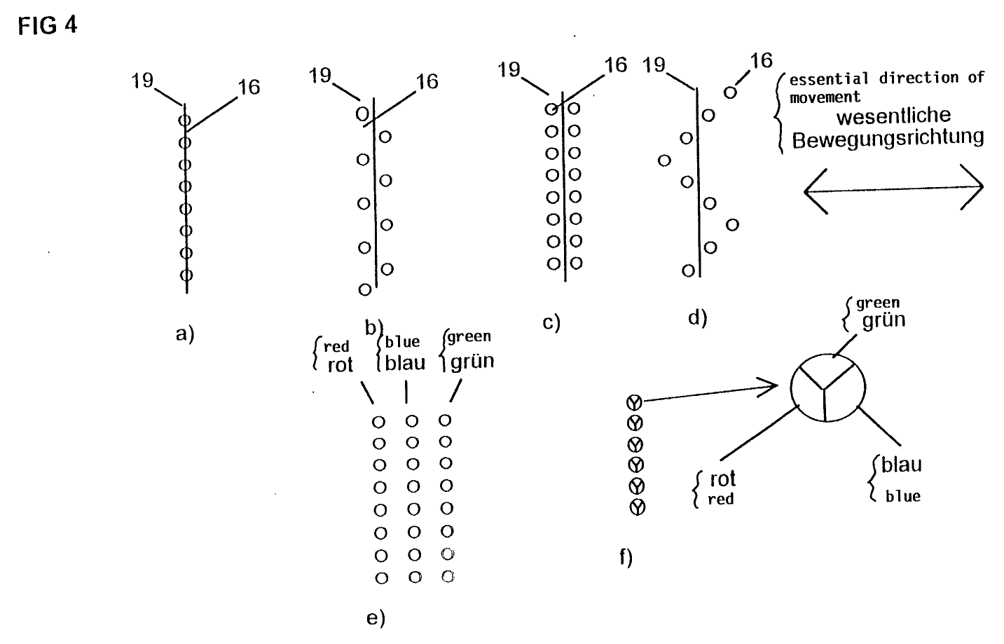

FIG. 4 shows various examples of light source arrangements,

FIG. 5 is a view of an arrangement of a plurality of display devices connected to a computer,

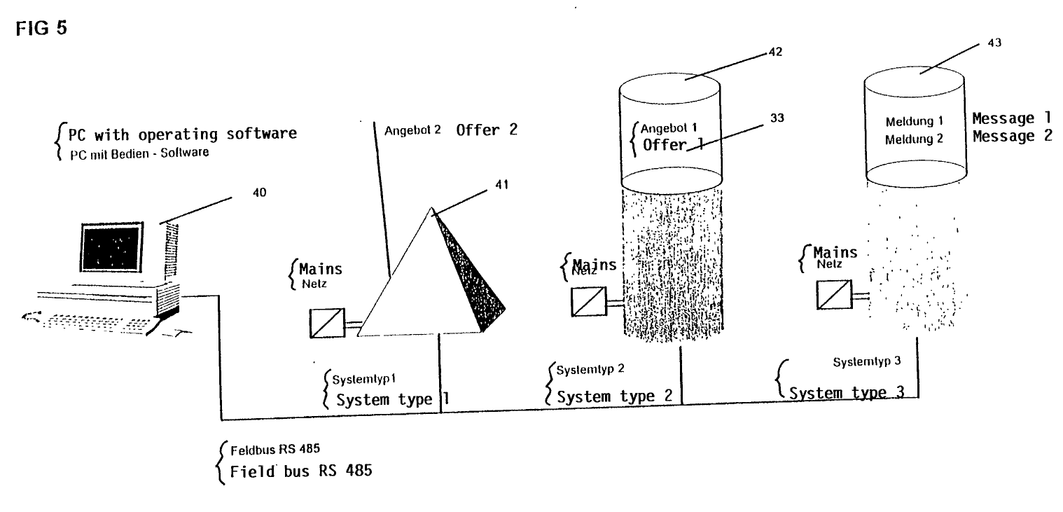

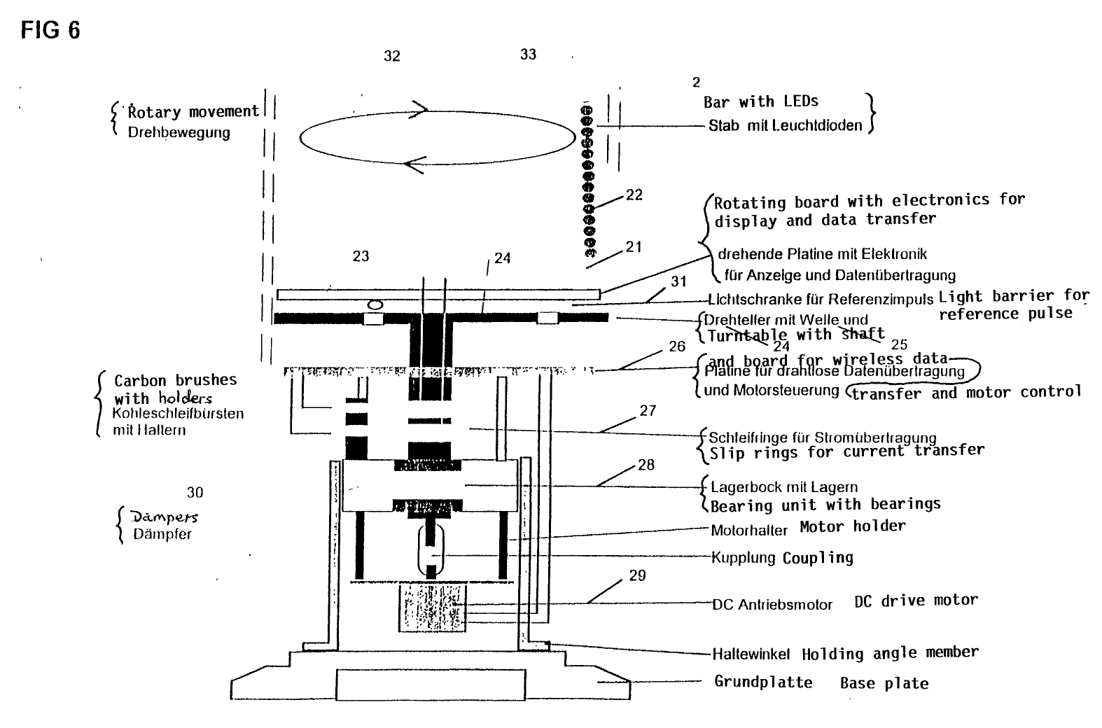

FIG. 6 is a view showing the principle of the structure of a display device with rotating light source carrier (advertising column structure),

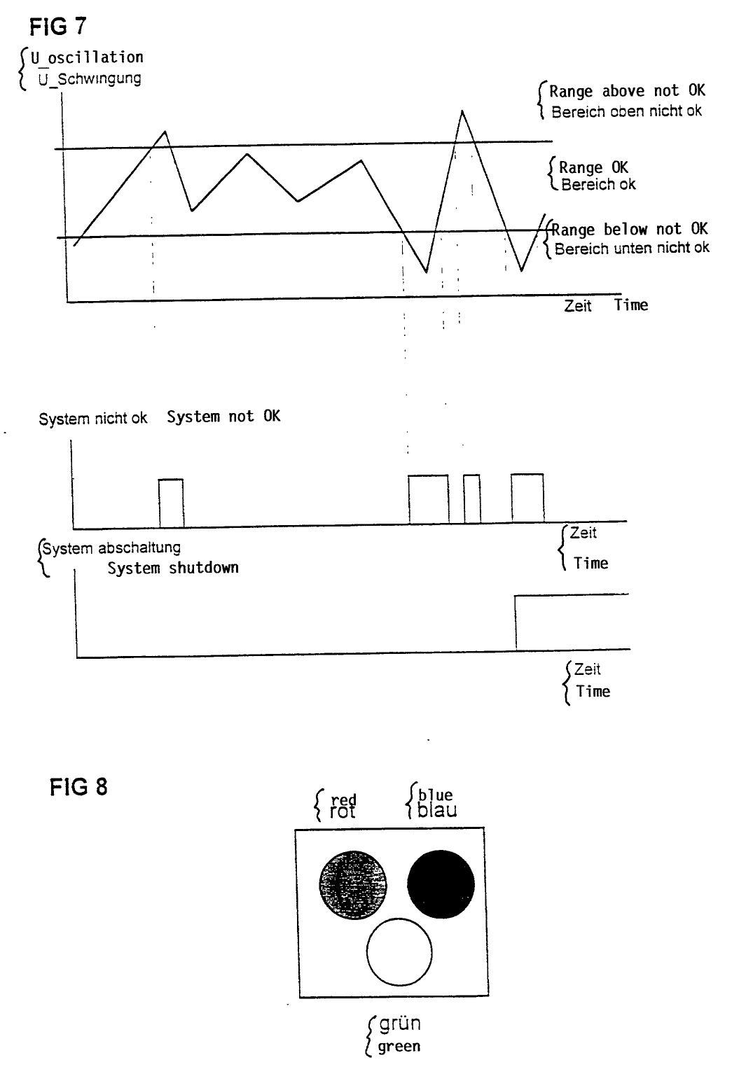

FIG. 7 shows an oscillation/time diagram of a display device according to the invention,

FIG. 8 shows a plan view of a colored light source arrangement,

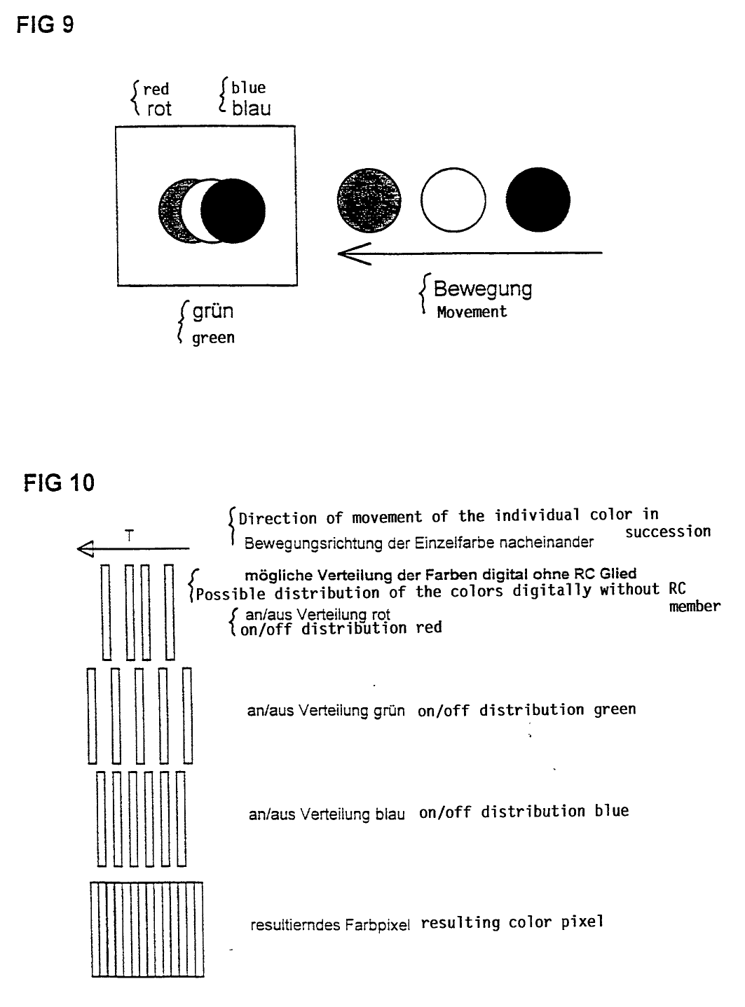

FIG. 9 shows a view of the coloration effect by the superimposition of moving colored light sources,

FIG. 10 shows an alternative configuration to the display illustrated in FIG. 9,

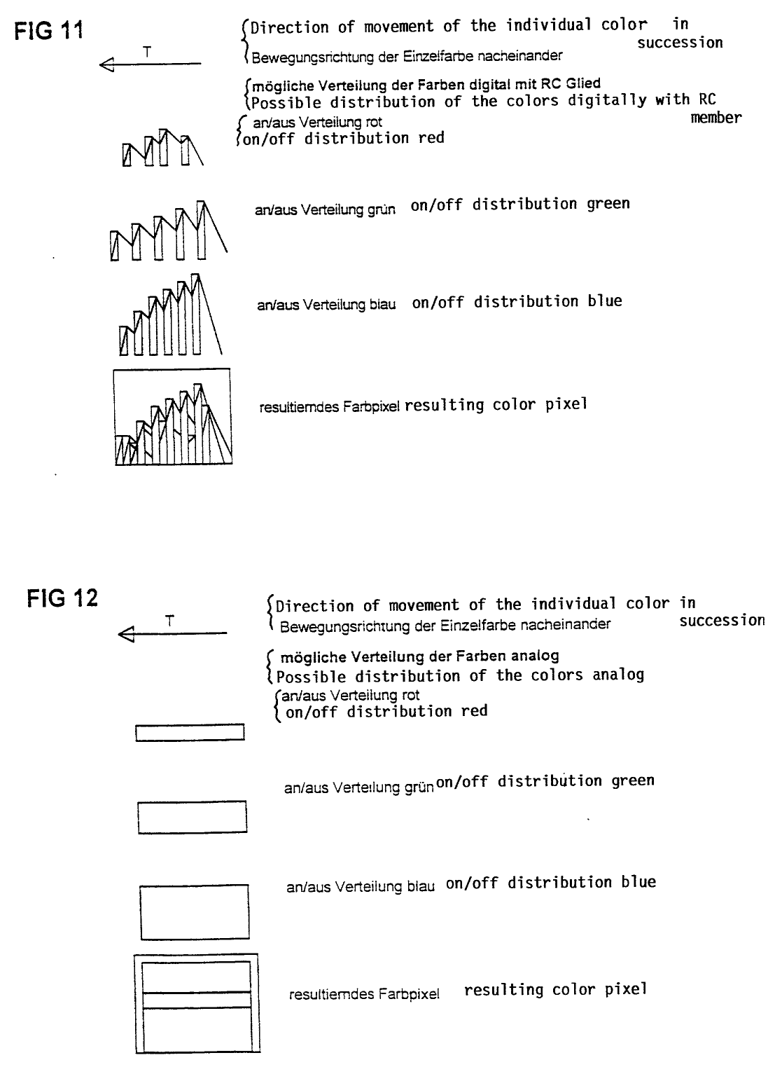

FIG. 11 shows a further alternative view for producing color,

FIG. 12 shows a further alternative view of producing color from individual colors,

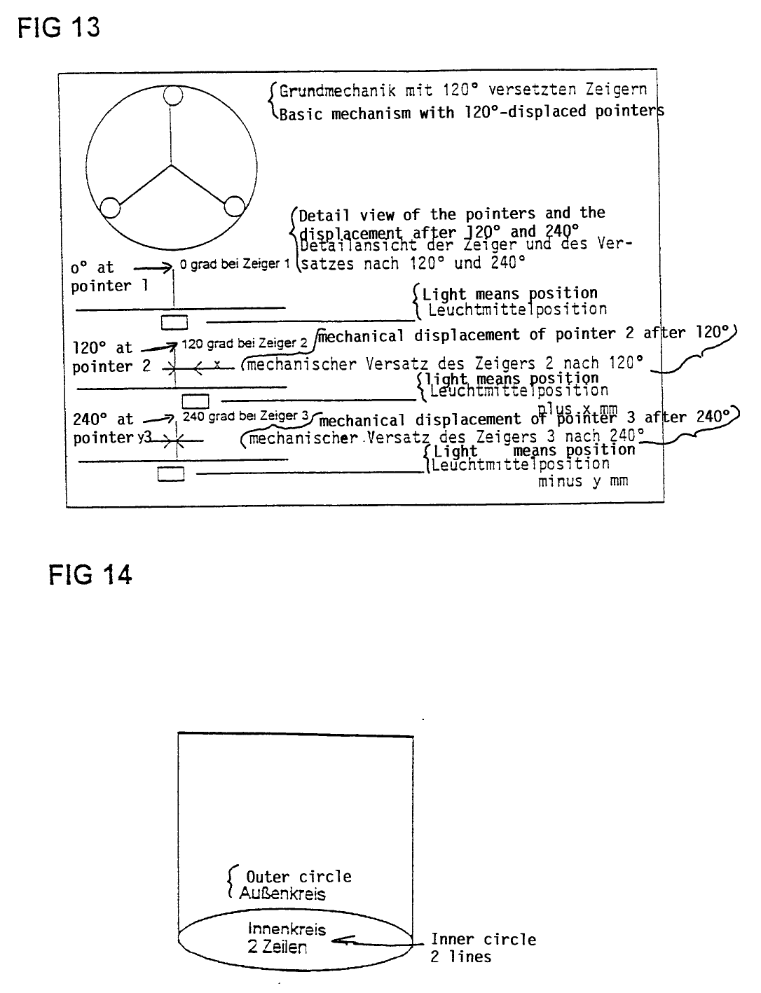

FIG. 13 is a view of electronic compensation of mechanical displacement of three pointers,

FIG. 14 is a view of a rotational display from below with a further display arranged at an inward location,

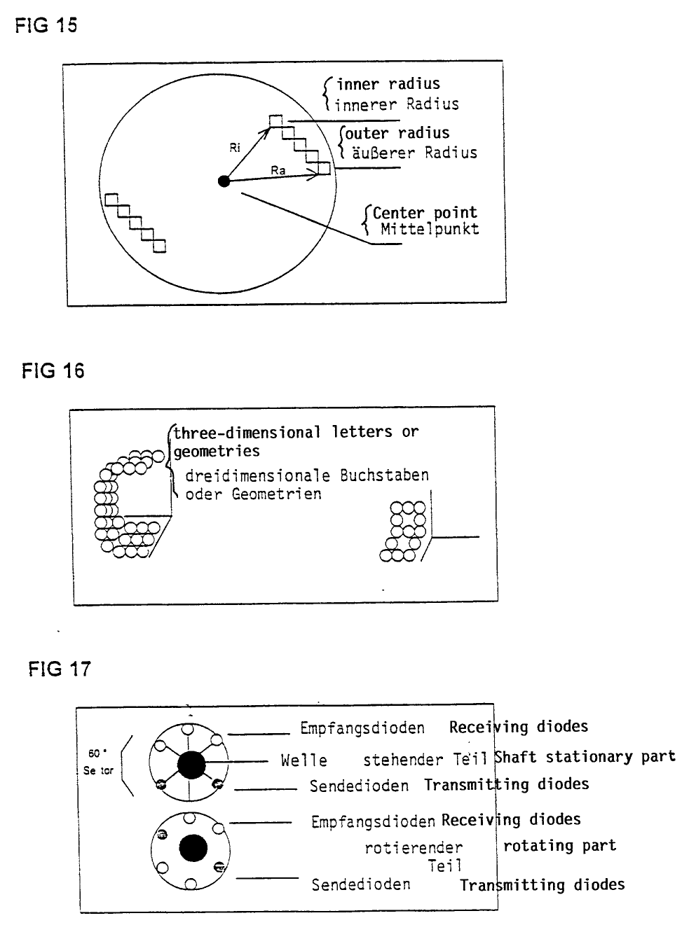

FIG. 15 is a view of a light source arrangement for generating a three-dimensional display,

FIG. 16 shows an example of a three-dimensional display generated by a light source arrangement as shown in FIG. 15, and

FIG. 17 shows an arrangement of receiving and transmitting diodes for contact-less infra-red data transfer.

FIG. 1 shows a carrier 2 which is in the form of pendulum arm 1 and on which light sources 3 in the form of light emitting diodes are arranged on the axis of the pendulum arm in a row in an array 16. The pendulum movement is excited by an electromagnetic unit or solenoid 4 which as a drive moves the pendulum arm 1 cyclically to and fro a plurality of times per second, for example more than 10 times. In a given position in the deflection movement of the pendulum, a portion 5 which can project parallel from the pendulum arm 1 or which coincides with the pendulum arm passes through or breaks a light barrier arrangement 6 having detectors, so that the movement of the pendulum arm generates a rectangular signal as a reference signal 15—see FIGS. 3a and b—or a reference pulse. The light barrier arrangement 6 comprises a light generator in the form of an infra-red LED and a detector. If the light barrier arrangement is interrupted by the portion 5 which is in the form of a reference plate, the reference pulse signal is generated in the connected control device 7—see FIG. 2.

The drive is controlled in dependence on the reference signal, by a control device 7—see FIG. 2. In that respect, the control device 7 provides that the pendulum 1 is excited as accurately as possible and thus performs an accurate movement, and in that respect passes over the same surface 17 so frequently per second, for example more than 10 times, that the pendulum arm 1 itself can no longer be discerned in the region of the display surface 17. It is only at the reversal points of the pendulum that the pendulum arm 1 appears as a line.

The control device 7 in FIG. 2 comprises a pendulum electronic unit 8 as the drive control and a control processor which is in the form of a microcomputer 9 and which generates control signals for the light sources 3 in the form of switch-on and switch-off pulses. The electronic pendulum circuit 8 is connected to the light barrier arrangement 6 which has a light generator and a detector. The signal which is excited by the movement of the pendulum arm 1 at the detector is produced in the pendulum electronic unit 8 or already at the detector itself in the form of a reference pulse signal 15 and is fed to the microcomputer 9 by way of a suitable line 10. At the same time, for exact oscillation 19 of the pendulum arm 1, a magnetic pulse signal 18 is outputted to the drive 4 which is in the form of the electromagnetic unit or solenoid so that the pendulum arm performs a stable and regular pendulum movement. It is highly advantageous if the pendulum arm is excited in such a way that it oscillates at its natural resonance frequency as then the power consumption for the drive is extremely slight. The natural frequency of the pendulum is determined by the pendulum mass and by the geometrical dimensions of the pendulum. The described drive operates entirely without mechanical wear as the pendulum is excited in a contact-less manner by the solenoid. That guarantees a totally noise-less and wear-free drive.

The entire display device is supplied with 5 volts dc voltage which is furnished by a mains unit 11 which converts ac voltage into dc voltage. It will be appreciated that it is also possible to ensure the necessary electrical power supply by means of batteries, accumulators or solar cells which are mounted on the display device.

The microcomputer 9 includes a storage means or memory and/or a clock which prepares or holds in store the items of information to be represented. At the same time the microcomputer implements conversion of the information to be represented into suitable actuation signals for each individual light source. For that purpose the reference signal is used for timed switching-on and switching-off of the light sources and thus for information display.

The relationship between reference pulse, magnetic pulse, pendulum oscillation build-up and information display is described hereinafter with reference to FIG. 3.

It should be pointed out that FIG. 3a and b each represent diagrammatic illustrations of the pulse and oscillation configurations, but they are not representations which are exact in respect of time.

FIG. 3a shows the relationship between reference pulse and magnetic pulse and the oscillation configuration or pattern. In that respect it can be noted that the magnetic pulse signal only represents a rectangular pulse signal which is displaced relative to the reference pulse signal. The reference pulse signal experiences a change at each passage-through-zero of the oscillation signal through the time axis, that is to say at the moment at which the pendulum arm reverses its direction of movement.

With reference to FIG. 3b, it will be seen that the reference signal, alternatively to FIG. 3a, also experiences a change when the speed of the pendulum arm is at its greatest. At the same time it can be seen that information reproduction occurs both in the forward movement of the pendulum arm and also in the return movement of the pendulum arm, that is to say whenever the pendulum arm passes over the display surface. Thus for example, with 12 oscillations of the pendulum arm, the display surface can be passed over 24 times and so-to-speak the light sources are correspondingly actuated 24 times so that 24 display images per second are generated. Such a number of display images per second is already sufficient to generate a still image which can be readily discerned by a viewer and the items of information of which can be suitably read. In that situation, the viewer in practice does not perceive the pendulum arm movement itself as the speed of the pendulum arm over the display surface is too great. At the same time the viewer does not perceive the switching-on and switching-off of the individual light sources, but he only sees individual light points which, as shown in FIG. 1, appear in the display in the form of light points which are comparable to a light point matrix.

The microcomputer 9 receives from the electronic pendulum circuit 8 the reference pulse signal 15 which is processed in the microcomputer 9 in such a way that the oscillation of the pendulum is present for the microcomputer as a defined time slice. That time slice is divided into forward-motion and return-motion information. In that time slice, at the correct time, the correct information is then outputted to the individual light sources so that the result is a clear item of image information which is built up in line form.

The quality of representation can be improved with an increasing speed of the light points or with an increase in the number of oscillations. Conversely, with a decreasing speed of the light points or with a decreasing number of oscillations of the pendulum arm, the representation becomes progressively worse and can scarcely be discerned any longer when the number of oscillations is excessively small as the persistence of the human eye is then no longer overcome. Synchronisation of actuation of the light sources in the forward movement and the return movement is so set by the control device 7 that both items of information are in optically superimposed relationship and thus coincide.

FIG. 4 shows some examples of light source arrangements which are suitable for the representation according to the invention. FIG. 4a shows the light source array 16 illustrated in FIG. 1. All light sources are arranged one behind the other on a straight line, like a linear light source chain. In FIG. 4b, an equal number of light sources are arranged as an alternative to FIG. 4a. In FIG. 4b, two rows of light source points are arranged in side-by-side relationship and in FIG. 4d the light source points are disposed on a zig-zag line. Further light source arrays are possible and may be more or less advantageous, depending on the respective situation of use involved. What is essential in regard to all light source arrays is that they are moved in a substantial direction of movement which is oriented transversely to a direction 19 of formation thereof, so that each individual light point, alone or together with one of the adjacent light points—see FIG. 4c—forms a display line of the display according to the invention. The light source arrays shown in FIG. 4 equally each permit a nine-line display. FIG. 4e shows a light source array of linearly arranged light sources, wherein the light sources arranged in the first vertical row produce red light, those in the second row produce blue light and those arranged in the third row produce green light. A light source array of that kind also makes it possible to provide colored displays, as the viewer is accustomed to see, from other color reproduction apparatuses such as for example a television or a color monitor.

FIG. 4f shows a light source array in which an individual light source has three segments, wherein each individual segment is capable of producing a color which is different from the other signals, so that a colored display and reproduction as described hereinbefore is also possible.

The items of information to be displayed can be stored in fixed or volatile form in the storage means or memory contained in the microcomputer 9, or they can be generated by means of a clock or another information-generating means. It is then possible that, instead of a digital clock time display, equally or alternatively thereto, the arrangement affords an analog clock time display in which the dial and the appropriate clock time pointer or hand position is produced with the display according to the invention. The microcomputer 9 then only effects a mode of light source actuation that is different from when the digital clock time display mode is involved. The display device according to the invention makes it possible to generate all kinds and forms of two-dimensional images which can also be generated with light point matrixes or other display picture screens. Optical wave guides, electric lines or also information buses can serve as a connection of the microcomputer to the light sources. If optical wave guides are used, the light sources employed can be the end portions of the respective optical wave guides which are oriented perpendicularly to the plane of the drawing in FIG. 1 so that the viewer looks onto the end portions.

The clock component which is integrated in the microcomputer and from which the time is read out continues to run even without operation of the mains unit so that there is no need for the clock to be re-set if the voltage supply should sometimes fail. Furthermore it is desirable if the display device has a brightness measuring device which is also connected (not shown) to the microcomputer 9. The brightness measuring device measures the ambient brightness and outputs a suitable signal to the microcomputer which in turn adjusts the light strength or power of the light sources in dependence on the measured brightness signal. It is thus possible for example to provide that the light sources light up more brightly in broad daylight than in a darker environment.

In particular light emitting diodes or incandescent lamps are suitable as the light sources, but it is also possible to use the end portions of optical wave guides or other known light sources of point form, which can be quickly switched on and off and which require little power.

Conversion of an item of information to be displayed, in the computer, into suitable actuation signals for the light source, is in principle known from actuation of a needle printer which involves the transmission of a defined item of information to the individual needles in each position. The horizontal travel of the print head of the needle printer over the paper subsequently shows the information involved. That principle of a needle printer is used in the present invention in a similar manner for switching the light sources on and off, in which respect the light source carrier, as described, has to be sufficiently quickly moved so that the persistence of the human eye is overcome.

FIG. 6 shows the basic structure of a display device in which the light source carrier performs a rotational movement about a fixed point of rotation and thus moves on a cylindrical path. In that way it is possible to provide a 360°-display, as in the case of advertising columns. In the display device in FIG. 6, the carrier is in the form of a bar 21 with light emitting diodes 22. The bar 21 stands on a rotatable board 23 on which the electronic arrangement for display and data transfer is disposed. Disposed beneath the rotating board and connected thereto is a turntable 24 which is driven by a shaft 25. For determining the position of the rotatable board 23, the arrangement has a detector which outputs a reference pulse to the electronic arrangement when the rotating board is in a given position.

The assembly further includes a further board 26 for wireless data transfer and for motor control. The board 26 is also connected to carbon brushes 27 for the transfer of current to the diodes 22. A bearing unit 28 carries the rotary shaft 25 and permits rotary movement thereof. The shaft 25 is driven by a drive motor which is connected to the board 26 in a wireless fashion or by wire connections and is controlled by the control device.

The rotational movement of the bar 21 and appropriate actuation of the light emitting diodes 22 permits a display in the manner of an advertising column, except with the difference that it is possible to see through the display itself. In the active condition, the user cannot discern how the items of information come onto the “advertising column”. Such a 360°-display has considerably advantages over a picture screen as the information to be displayed can be made accessible in all directions, in particular when the information to be displayed rotates in the form of moving script or lettering around the advertising column.

In a further embodiment (not shown) the carbon brushes illustrated in FIG. 6 are replaced by a generator-type structure, that is to say, carried on the shaft itself is the rotor of a current generator which is surrounded by the stator. That arrangement permits contact-less or momentless power transfer which from the outset avoids the wear of carbon brushes and in addition contributes to reducing noise.

Instead of only one bar 21 it will be appreciated that it is also possible to provide a plurality of bars having light emitting diodes, which has the consequence that the speed of rotation can then be reduced. As in any case relatively high centrifugal forces act on an individual bar, it is advantageous to respectively arrange in mutually opposite relationship bars which are connected together at the free ends in order thereby to ensure a bar arrangement which affords structural security. In addition, it is desirable for the rotatable part, that is to say bar and rotatable board and also the turntable, to be covered with a cylinder having a transparent wall in order to prevent collisions between the bar and other articles. If the interior of the cylinder is pumped empty of air, the reduction in noise can be improved as there is then no longer the possibility of air molecules colliding with the bar. If only one bar is provided in the structure shown in FIG. 6, the rotational frequency should be about 25 Hz in order to permit a display of attractive quality. In each revolution, a light barrier assembly pulse is produced, which is supplied as a reference signal to the electronic control system and thus permits synchronisation.

FIG. 5 shows the structure in principle of a display system comprising various display devices 41, 42—either with a pendulum display or with an advertising column display—which are connected by way of a bus—for example BRS 485—to a personal computer as the information input/processing device 40. By virtue of such a configuration, paired with suitable PC-software which allows display control of the individual display devices, it is possible to input suitably desired display information, to put the information into intermediate storage in the PC, and to output that stored information to the display devices where the information is then reproduced.

Preferably, each individual display device is provided with an electronically selectable address so that the PC can not only select all display devices simultaneously but also individually, for information reproduction. Such an address can be for example a digitally encoded number.

Addition to the rotational display in accordance with patent application No 195 02 735.3 or PCT/DE96/00117.

### Overview of the Supplemental Points

Automatic monitoring of the regular operating condition of the system is absolutely necessary in order always to be able to guarantee the safety of this system. The system develops enormous forces which in the operating condition are checked to ensure that they are in balance. The basic principle involved in this respect is that the system rotates and all forces are in equilibrium. If for any reason for example a component in the system were to come loose, an unbalance would occur, depending on the respective weight and position of the component. The inevitable consequence of that unbalance is that the system vibrates. That vibration is detected and electronically evaluated. If that unbalance is registered over a certain period of time (being of a value which is above or below a threshold value), the system is automatically switched off. This means that the system must always be in a defined condition in order to start up at all.

As can be clearly seen in FIG. 7, the fact that a valid operating range is exceeded does not directly result in the system being switched off. It is only when the fact that the operating range is exceeded is detected over a certain period of time, that the system shut-down procedure comes into operation. That system shut-down procedure can only be deactivated by pressing a switch. The condition of shut-down of the system also results in the generation of a message by way of the communication bus to the main computer.

Oscillation damping of light vibrations is effected by way of vibration dampers or arrangements referred to as rubber-metal damping connections. The use of such vibration dampers involves two essential purposes. On the one hand, light frequencies (for example noise) are not transmitted to the fixed basic frame structure. On the other hand, for vibration measurement purposes, it is possible to use a light barrier arrangement which can measure the mechanical difference between fixed and oscillatingly mounted parts. The signal U_ oscillation can thus be very easily produced.

Each rotational system must be subjected to factory setting after assembly. That setting is necessary in order to compensate for differences which have occurred in the course of production. It will be very difficult to build a system which immediately runs true. Thus for example in the case of any motor vehicle the tires always have to be balanced in order to guarantee optimum running truth thereof. That problem also occurs in the case of a rotational display system. In order to be able to detect that unbalance, the signal U_oscillation is simply viewed with an oscilloscope. That signal is to be brought to a condition of perfect synchronism by the fitting of suitable weights. The problem in this respect is not detecting and optimising static unbalance but dynamic unbalance.

The rotational system for the first time affords the possibility of displaying colors of lighting means mechanically one above the other. Based on the fact that, at certain frequencies, the human eye mixes individual pulses to constitute an image, it is possible in this respect to have recourse to that effect. Conventional displays such as for example a television or an LED-wall mix the primary colors red, green and blue. The disadvantage however lies in the resolution. The colors are displayed in side-by-side relationship. If the human eye is not sufficiently far away from that point, the human being does not see the three individual colors separately, but combines them to form a mixed color from the relationship of the individual colors.

By virtue of mechanical mixing of the lighting means red, green and blue in a suitable ratio, the resulting color can be produced at a virtually virtual point.

It is thus possible to achieve a very high degree of resolution as the mechanical limitation in regard to the light point ceases to apply. Digital mixing of the colors over a point is effected by suitable actuation (on-off). That has the advantage that electronic actuation becomes very simple. The intensity of the individual primary colors is controlled by a suitable pulse duty factor. The information is ready in a suitable storage means. The digital mixing method can be suitably adapted by virtue of connecting an RC-member into circuit, as an RC-member acts like an integrator.

The RC-member in an actuation system must be suitably tuned to the display frequency. That provides a virtually analog adaptation effect.

In addition however it is also possible for the color pixel to be operated with a suitable level of intensity over the period of time T. That however requires a relatively complex hardware set-up.

For the time T. the pixel must reach and hold a suitable level of intensity.

The use of three colors is achieved preferably with three bars which are in a 120°-relationship with each other. Each bar includes either all three primary colors or each bar includes only one primary color. At any event, there must be synchronisation of the three colors at the corresponding moment in time T. A minimal displacement would result in an indistinct and blurred image. Furthermore, it is not possible to absolutely guarantee that all pointers are always mechanically disposed, with the lighting means, on the same vertical axis. Minor errors caused by the production procedure will always be present. In order not to mechanically measure and especially compensate for that point, the electronic system operates to compute a displacement of 120° and a suitable production error is incorporated in the computation as a compensation factor.

It can be seen from FIG. 13 that the pointer 2 at plus×mm and the position of the pointer 3 of minus y mm deviate from the ideal position.

That displacement remains disregarded in production and is only individually detected in the procedure for final testing for each system. In that respect the speed of rotation is irrelevant. The calculation of the 120° support points is ascertained with each passage and is recalculated for the following passage. In that case, the displacement differences are also suitably incorporated in the computation. Input of the differences is effected with a suitable service and setting software program.

The use of a motor regulation arrangement is not absolutely necessary in this system. By virtue of the 120° computation, the system is capable of measuring the speed of rotation only by measurement of the revolution duration by means of a light barrier arrangement. The resulting computation of the system-typical parameters is thus implemented in respect of each revolution. That in turn makes it possible to use simple, unregulated drives. These systems are less expensive. As the controller on the system does not communicate the display data directly to the pointers, it has sufficient time for that higher-order calculation.

The arrangement of lighting means on the inner circle makes it possible also to make better use of the display surface area. That is particularly advantageous in regard to systems which are mounted under the cover. Not only the outer peripheral surface but also the inner peripheral surface are used. Thus, when viewing from below, a part of the information can also be read in the inner region.

By way of a pointer arrangement extending into the middle space, it is also possible to show physical letters or three-dimensional parts.

The lighting means which are disposed on the outer radius are displayed with the lighting means which are disposed continuously further inwardly. It is thus possible to give a suitable depth to a lighting point. The lighting means are also arranged one below the other on the pointers.

Letters or geometries can also be spatially represented by way of the depth effect.

The contact-less infra-red data transfer of the systems is bi-directional. This means that data are simultaneously transmitted and received. It is thus also possible for status information to be communicated from the system to the main computer. Furthermore, items of data information are acknowledged as being correctly received by the system. Data transfer is effected in each case by way of two transmitting diodes and three/four receiving diodes which are so arranged that they can always transmit and receive at any time in the revolution. The arrangement can be seen in FIG. 17. The particularity of the arrangement is that, at any rotational relationship, the arrangement always ensures that it is possible to both transmit and also receive. The spacing of the elements is always 60° relative to each other. In the case of the stationary part, it is even possible to omit a receiving diode.

1. A display device having
a plurality of light sources (3) arranged on a carrier (2),
a control device (7) for actuation of an individual light source (3) and/or a sub-group of light sources (3),
with a drive (4) which is controlled by the control device and which is so connected to the carrier and so moves it that the light sources (3) pass repetitively a plurality of times over a surface region (17) within a given unit of time, and
a storage means connected to the control device (7) for the storage of an item of display information,
characterised in that arranged on the carrier are light sources of a plurality of different chromaticities (red, green, blue) and that for color mixing light sources of a different chromaticity are switched on at one and the same position (pixel) or at positions of very close proximity.

2. A display device as set forth in claim 1 characterised in that to provide for the desired color production the pulse duty factor of a single light source is controllable and that preferably an RC-member serves for integration of the digital on/off signals of an individual light source.

3. A display device as set forth in one of the preceding claims characterised in that the light strength of a light source is controllable and that for mixing a color from a plurality of primary colors the light intensity of a light source is set for a predetermined period of time (t).

4. A display device as set forth in one of the preceding claims characterised in that the display device is a rotational display device having at least two light source carriers which are arranged at an angular relationship of about 180° relative to each other, wherein each carrier has one or more primary color light sources, and that electronically associated with the second carrier or the light sources of the second carrier is an item of mechanical displacement information which specifies the number of degrees or millimeters by which the carrier or the light sources of the carrier are displaced from the ideal 180° position, and that a mechanical displacement between the carriers or the light sources of the carriers is effected by controlledly switching on the light sources, using the stored items of mechanical displacement information.

5. A display device set forth in claim 4 characterised in that the mechanical displacement difference of the second carrier to the first carrier is stored in non-volatile mode.

6. A display device as set forth in one of the preceding claims characterised in that there are provided means for detecting the speed of rotation of the light source carriers or the light sources.

7. A display device as set forth in one of the preceding claims characterised in that individual light sources are at a different spacing relative to the center point of the axis of rotation.

8. A display device as set forth in one of the preceding claims characterised in that there are provided means for detecting the speed of rotation or the rotational speed of the light source carriers or the light sources.

9. A display device as set forth in one of the preceding claims characterised in that there is provided a display data input unit (107) which can input the item of information to be displayed, by the user, and that the data input unit is electrically coupled to a data store for storage of the display data on the control board (103).

10. A display device as set forth in one of the preceding claims characterised in that the light source carrier is on the one hand electrically and mechanically connected to a board (103) (FIG. 2) and is connected at its other end by way of a connecting means (104) to a holding portion (105) which is arranged approximately at the center of rotation (106).

11. A display device as set forth in one of the preceding claims characterised in that there are provided means for detecting a mechanical vibration of the display device and switching means which preferably switch off the display device under the control of the vibration-detecting means when a mechanical vibration has been detected at least over a predetermined period of time and/or a predetermined vibration threshold has been exceeded over a predetermined period of time.

12. A display device as set forth in claim 11 characterised by vibration-damping means arranged between the moving parts of the display device and a stationary main frame structure of the display device.

13. A display device as set forth in claim 11 or claim 12 characterised in that the means for mechanical vibration absorption are used for detecting a dynamic eccentricity and that the display device has a disk-like carrier on which there are preferably arranged positions for disposing weights.

14. A display device as set forth in one of the preceding claims characterised in that the carrier (2) is arranged at an angle that is different from 90° or 0° relative to the line (100) normal to the movement, preferably through an angle of about 30°-60°.

15. A display device as set forth in claim 14 characterised in that there are provided a plurality of light source carriers (2) which pass rotatingly over a surface region and that the carrier (2) is so arranged that it is inclined at approximately 30°-60° relative to the vertical direction (100).
